(19) United States
(12) Patent Application Publication
(10) Pub. No.: US 2007/0029785 A1
(43) Pub. Date: Feb. 8, 2007

(54) Security paper, particularly for labels

(76) Inventor: Giuseppe Fedrigoni, Verona (IT)

Correspondence Address: Modiano & Associati, Via Meravigli 16, Milano, 20123, IT

(21) Appl. No.: 10/558,203

(22) PCT Filed: Jun. 15, 2004
(86) PCT No.: PCT/EP04/06430

§ 371 Date: Nov. 25, 2005

(30) Foreign Application Priority Data
Jun. 20, 2003 (IT) VR2003A000079

(51) Int. Cl. B42D 15/00

(52) U.S. Cl. 283/72

(57) ABSTRACT

A security paper, comprising a first and a second outer layers and at least one intermediate layer that is interposed between the first and second outer layers, the first outer layer being coupled to the intermediate layer so as to form a monolithic body, and the intermediate layer having a different coloring with respect to the first and second outer layers.

### TECHNICAL FIELD

The present invention relates to a security paper particularly but not exclusively suitable for marking food products.

### BACKGROUND ART

Currently the need is particularly felt to mark products, specifically food products such as meat, fish, et cetera, by means of labels or similar media that allow, by imprinting an abbreviation or a bar code, to trace the “history” of the product (country of origin, farm where the animal was raised, date of birth and/or slaughter, location where slaughter took place, et cetera).

However, these labelings, and particularly the media on which these data must be imprinted, must have the characteristic of being difficult to duplicate and/or reproduce: in practice, they must be “forgery-proof” papers in every respect, in order to prevent marketing of products that bear false labeling and whose origin would therefore be impossible to determine with certainty.

### DISCLOSURE OF THE INVENTION

The aim of the present invention is to provide a security paper, particularly but not exclusively suitable for marking food products.

Within this aim, an object of the invention is to provide a a security paper that allows to check its authenticity in a simple and straightforward manner.

Another object of the security paper according to the invention is to allow, following specific tests, an extremely reliable verification of its authenticity.

Another object of the present invention is to provide a security paper that has a competitive production cost, so as to be extremely advantageous also from an economical standpoint.

This aim and these and other objects that will become better apparent hereinafter are achieved by a security paper according to the invention, characterized in that it comprises a first and a second outer layers and at least one intermediate layer that is interposed between said first and second outer layers, the first outer layer being coupled to the intermediate layer so as to form a monolithic body, the intermediate layer having a different coloring with respect to the first and second outer layers.

Conveniently, a security paper according to the invention is characterized in that the monolithic body is stably coupled to the second outer layer.

As an alternative, a security paper according to the invention is characterized in that the second outer layer is detachably coupled to the monolithic body.

More particularly, according to the invention, a security paper is characterized in that the monolithic body is constituted by a multi-layer paper medium, with the layers, different one another, that are coupled in continuous.

According to another aspect, the present invention provides a method for producing a security paper comprising the following operating steps:
a step for the stable coupling of a first outer layer and an intermediate layer so as to obtain a monolithic body;
a step for coupling said monolithic body and a second outer layer, said intermediate layer having a coloring that is different from the coloring of said first and second outer layers.

Conveniently, a method for producing security paper according to the invention is characterized in that the stable coupling for obtaining the monolithic body comprises a method for producing a medium composed of plural, even different, layers arranged one over another and wet coupled together.

### BRIEF DESCRIPTION OF THE DRAWINGS

Further characteristics and advantages of the invention will become better apparent from the description of some preferred but not exclusive embodiments of a security paper and of a method for producing it according to the invention, illustrated by way of non-limiting example in the accompanying drawings, wherein:

FIG. 1 is a perspective view of a portion of a security paper according to a first embodiment;

FIG. 2 is a view of a different embodiment of a security paper according to the invention;

FIG. 3 is a perspective view of an identification label for food products, obtained from a security paper according to the present invention;

FIG. 4 is a perspective view of a security paper, showing the graphic elements that are visible in transmitted light;

FIG. 5 is an enlarged-scale perspective view of a security paper according to the invention;

FIG. 6 is a diagram of the main steps for the production of a security paper according to the invention; and

FIG. 7 is a diagram, similar to FIG. 6, for the production of an adhesive security paper, also according to the invention.

### WAYS OF CARRYING OUT THE INVENTION

In the examples of embodiments that follow, individual characteristics, given in relation to specific examples, may actually be interchanged with other different characteristics that exist in other examples of embodiments.

Moreover, it is noted that anything found to be already known during the patenting process is understood not to be claimed and to be the subject of a disclaimer.

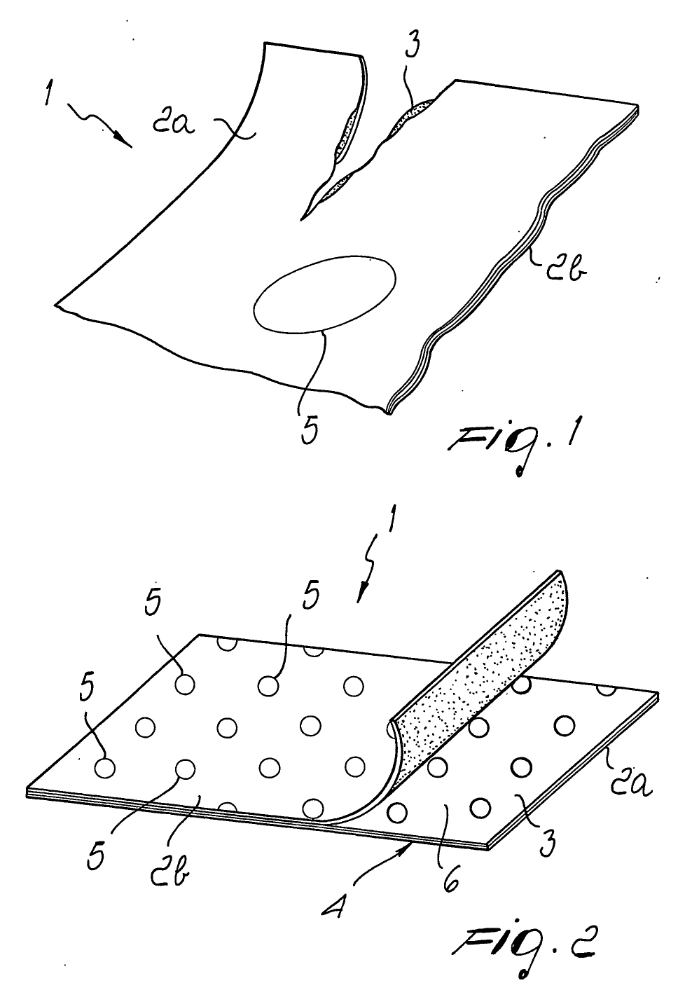

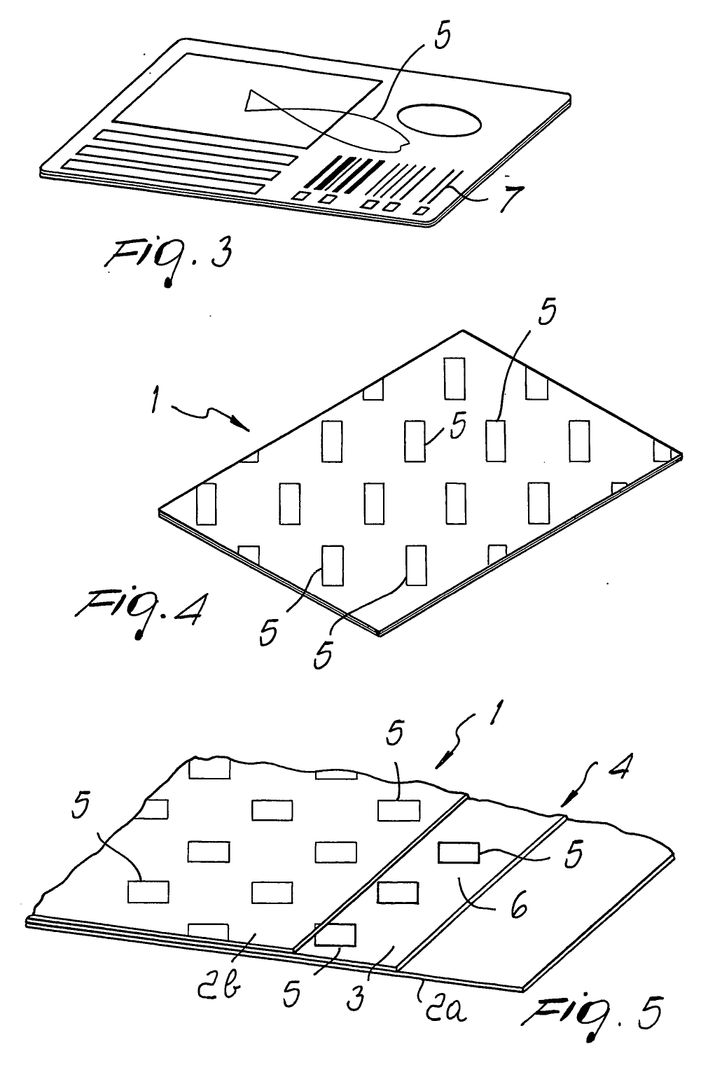

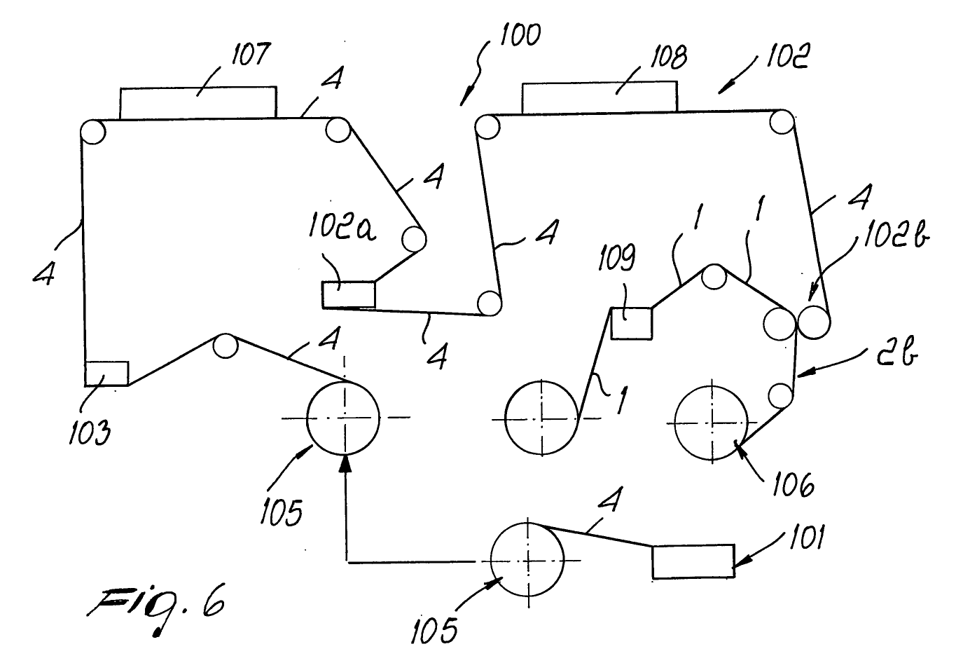

With reference to the figures, and particularly to FIGS. 1 to 5, a security paper according to the invention, generally designated by the reference numeral 1, is constituted by a first outer layer 2a, a second outer layer 2b, and at least one intermediate layer 3, which during use is interposed between the first outer layer 2a and the second outer layer 2b.

In particular, according to the invention, the first outer layer 2a is coupled to the intermediate layer 3 in order to form a monolithic body 4.

This coupling, which can be defined as a stable coupling, between the first outer layer 2a and the intermediate layer 3 can be obtained by known methods, such as for example pasting.

However, according to a preferred embodiment, the monolithic body 4 is constituted by a plurality of fibrous layers, even different one another, coupled with a wet process, on a continuous machine.

Such medium is constituted by a two-layer element that is produced directly along the paper production line instead of by coupling two individual layers.

The layers of paper (which in this case have different colors) are pressed together while they are still in pulp form and the drained water of each individual layer is collected separately to ensure high cleanliness of the individual layers.

This method allows to obtain a monolithic body 4 in which the first outer layer 2a and the intermediate layer 3 can however be identified easily; a laboratory analysis, however, allows to check whether the stable coupling is obtained outside the machine or by the wet method on the continuous machine.

Also according to the invention, the intermediate layer 3 has a different coloring with respect to the first outer layer 2a and the second outer layer 2b.

According to a first embodiment, shown in FIG. 1, the second outer layer 2b is also coupled stably, for example by pasting, to the monolithic body 4. In this regard, in order to obtain a satisfactory result it is possible to interpose a layer of adhesive during the process for producing the security paper 1 (which will be thoroughly described hereinafter).

According to a different embodiment, the second outer layer 2b can be detachably coupled to said monolithic body so as to obtain, for example, an adhesive medium such as a true adhesive label.

In this last case, it is possible to provide a layer of silicone material to be interposed between the layer of adhesive and the second outer layer 2b.

Also according to the invention, a security paper 1 can have at least one graphic identification element 5 that is visible in transmitted light.

In particular, said graphic identification element 5 can be advantageously obtained by printing, which is performed by using per se known printing devices, at the face 6 of the monolithic body 4 that is directed toward the second outer layer 2b (and is therefore designed to be coupled to the second outer layer 2b).

Conveniently, in order to allow immediate viewing of the graphic identification element 5, the first outer layer 2a and the second outer layer 2b are not completely opaque.

Also according to the invention, in order to allow to imprint on the security paper 1 the identification data of the food product (for example by printing a bar code 7), at least one layer between the first outer layer 2a and the second outer layer 2b can be printed for example by laser or ink printing, inkjet printing, direct or indirect thermal transfer printing, and more generally by any more or less traditional printing systems.

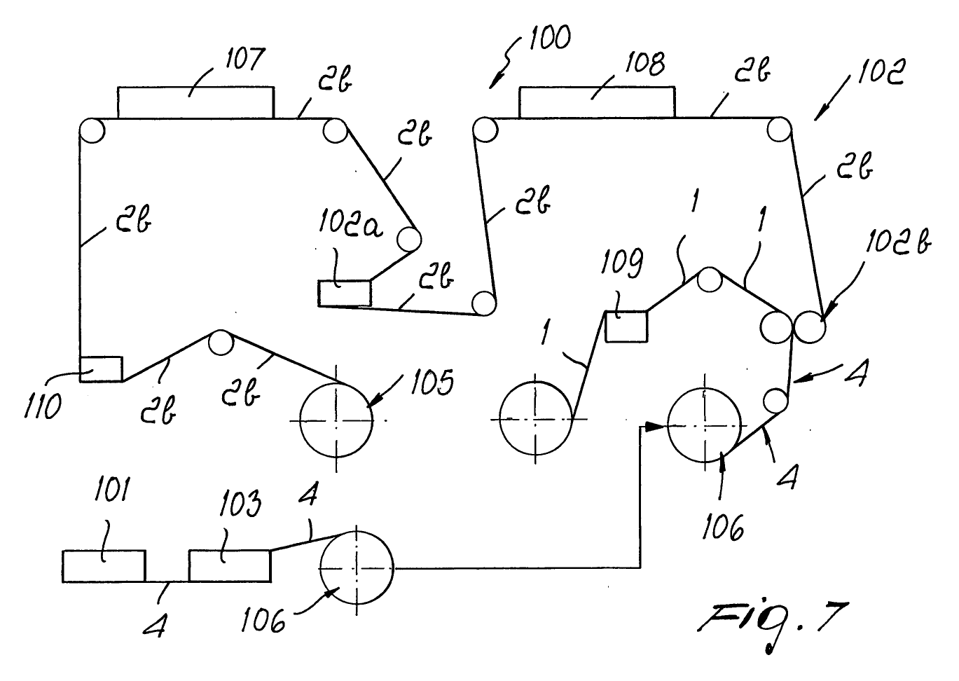

According to another aspect, and with particular reference to the diagram shown in FIG. 6, the present invention provides a method for producing a security paper 1, comprising the following operating steps:
a step 101 for the stable coupling of a first outer layer 2a to an intermediate layer 3 in order to obtain a monolithic body 4;
a step 102 for coupling the monolithic body 4 and a second outer layer 2b one another.

As clearly described earlier, the intermediate layer 3 has a different coloring with respect to the first outer layer 2a and the second outer layer 2b.

In particular, step 101 for stable coupling to obtain the monolithic body 4 is achieved by means of a known method for producing a medium composed of a plurality of fibrous layers, as previously defined (see for example page 4), which constitutes the monolithic body 4.

Advantageously, the step 102 for coupling the monolithic body 4 (first roll 105) and the second outer layer 2b (second roll 106) one another is performed by means of a step 102a for coating with adhesive said monolithic body 4 at its surface (or face 6) that is intended to be coupled to the second outer layer 2b and by means of the simultaneous passage of the adhesive-coated monolithic body 4 and of the second outer layer 2b through at least one coupling calender 102b.

Again with reference to FIG. 6, the method 100 for producing security paper 1 according to the invention can have, prior to the adhesive coating step 102a, a step 103 for printing at least one graphic identification element 5 at the surface (the face 6) of the individual body 4 that is intended to be coupled to the second outer layer 2b.

Furthermore, according to a preferred method, a first drying tunnel 107 can be provided between the printing step 103 and the adhesive coating step 102a, while a second tunnel 108 for drying the adhesive layer can be provided likewise between the adhesive coating step 102a and the coupling step 102b.

Advantageously, downstream of the coupling calender 102 a rehumidification unit 109 is provided.

It is possible to provide for a variation of the present method 100, shown in FIG. 7, between the monolithic body 4, on which the graphic identification elements 5 have been optionally printed (second roll 6) and the second outer layer 2b (first roll 105).

In this case, upstream of the adhesive coating step 102a (of the second outer layer 2b) there is a station 110 for siliconizing the surface of the second layer 2b that is designed to be subsequently coupled to the monolithic body 4.

As in the method described earlier, in this case also, the coupling between the monolithic body 4 and the second outer layer 2b occurs at a coupling calender 102b, and during the coupling step the layer of adhesive is transferred from the second outer layer 2b to the face 6 of the monolithic body 4.

The operation of a security paper particularly but not exclusively suitable for marking food products according to the invention is evident from what has been described above.

In particular, it is possible to print on the security paper 1 an identification code (constituted for example by a bar code 7) that is capable of allowing at all times identification of the history of the product to which such code refers.

Merely by way of example, in the case of seafood, it is possible to fix, for example by means of a tamper-evident fixing stud, the security paper to the gill of the fish.

If one wishes to verify the authenticity of the security paper 1 associated with the food product, it is possible to verify first of all whether the graphic identification element 6 visible in transmitted light (against the light) is present or not, and secondly it is possible to tear the security paper 1 to see whether the intermediate layer 3, of a different color with respect to the two outer layers 2a and 2b, is present.

However, if doubts remain regarding the authenticity of the security paper 1, it is possible, by means of a laboratory test, to check whether the monolithic body 4 is actually constituted by a wire-and-drum medium.

The investment required to obtain a wire-and-drum medium is in fact very high and the industrial organizations capable of producing such a medium are numerically very few and in any case identifiable.

All the characteristics of the invention designated above as advantageous, convenient or the like may also be omitted or be replaced with equivalents.

The invention thus conceived is susceptible of numerous modifications and variations, all of which are within the scope of the appended claims.

Thus, for example, the security paper 1 can be covered by a layer of varnish or by a layer of polymeric material to prevent factors such as for example humidity from compromising its appearance and functionality.

According to another embodiment, which is conceptually similar, the first and second outer layers 2a and 2b themselves can be made of optionally printable polymeric material, such as polypropylene.

Another possible solution provides a security paper 1 in which two or more intermediate layers 3 are inserted between the first outer layer 2a and the second outer layer 2b in order to increase the degree of safety.

In practice it has been found that the security paper thus described can ensure the possibility to verify its authenticity by direct or indirect inspection.

Moreover, it has been demonstrated that the invention has achieved the intended aim and objects in all its embodiments.

In practice, the materials used, so long as they are compatible with the contingent use, as well as the dimensions and shapes, may be any according to requirements.

All the details may further be replaced with other technically equivalent elements.

The disclosures in Italian Patent Application No. VR2003A000079 from which this application claims priority are incorporated herein by reference.

What is claimed is:

1-16. (canceled)

17. A security paper, comprising a first and a second outer layers and at least one intermediate layer that is interposed between said first and second outer layers, said first outer layer being coupled to said at least one intermediate layer so as to form a monolithic body, said at least one intermediate layer having a different coloring with respect to said first and second outer layers.

18. The security paper according to claim 17, wherein said monolithic body is stably coupled to said second outer layer.

19. The security paper according to claim 17, comprising a layer of adhesive that is interposed between said monolithic body and said second outer layer.

20. The security paper according to claim 17, wherein said second outer layer is detachably coupled to said monolithic body.

21. The security paper according to claim 17, comprising a layer of silicone material and a layer of adhesive interposed between said second outer layer and said monolithic body.

22. The security paper according to claim 17, wherein said monolithic body comprises a paper medium composed of a plurality of fibrous layers, coupled by a wet process.

23. The security paper according to claim 17, comprising at least one graphic identification element that is visible in transmitted light.

24. The security paper according to claim 23, wherein said graphic identification element is printed at the face of said at least one intermediate layer that is directed toward said second outer layer.

25. The security paper according to claim 17, wherein said first and second outer layers are at least partially transparent.

26. The security paper according to claim 17, wherein said first and/or second layers are printable.

27. A method for producing security paper, comprising the steps of:
stably coupling a first outer layer and at least one intermediate layer in order to obtain a monolithic body; and
coupling one another said monolithic body and a second outer layer, said at least one intermediate layer having a coloring that is different from the coloring of said first and second outer layers.

28. The method for producing security paper according to claim 27, wherein said stable coupling to obtain a monolithic body comprises steps for producing a medium composed of a plurality of fibrous layers, superimposed and coupled by a wet process.

29. The method for producing security paper according to claim 27, wherein said step for coupling said monolithic body and a second outer layer comprises a step of coating with adhesive said monolithic body at its surface that is designed to be coupled to said second outer layer and the simultaneous passage of said adhesive-coated monolithic body and of said second outer layer through at least one coupling calender.

30. The method for producing security paper according to claim 27, wherein said step of coupling said monolithic body and a second outer layer comprises a step of coating with adhesive said second outer layer at the surface that is designed to be coupled to said monolithic body and the simultaneous passage of said adhesive-coated monolithic body and of said second outer layer through at least one coupling calender.

31. The method for producing security paper according to claim 30, further comprising, before said step of coating with adhesive said second outer layer, a step of siliconizing the surface of said second layer that is designed to be coupled to said monolithic body.

32. The method for producing security paper according to claim 29, further comprising, before said adhesive coating step, a step of printing at least one graphic element at the surface of said monolithic body that is designed to be coupled to said second outer layer.
